(19) United States
(12) Patent Application Publication
(10) Pub. No.: US 2014/0254429 A1
(43) Pub. Date: Sep. 11, 2014

(54) SIGNALING FOR DEVICE-TO-DEVICE WIRELESS COMMUNICATION

(71) Applicant: Broadcom Corporation, Irvine, CA (US)

(72) Inventors: Haiming Wang, Beijing (CN); Chunyan Gao, Beijing (CN); Na Wei, Beijing (CN); Wei Bai, Beijing (CN)

(21) Appl. No.: 14/349,107

(22) PCT Filed: Oct. 2, 2011
(86) PCT No.: PCT/CN2011/080511

§ 371 Date: Apr. 2, 2014

(51) Int. Cl. H04W 48/16; H04W 76/02

(52) U.S. Cl. CPC H04W 48/16; H04W 76/023
USPC 370/254

(57) ABSTRACT

The specification and drawings present a new method, apparatus and software related product (e.g., a computer readable memory) for implementing a direct device-to-device communication of cellular devices, e.g., in LTE wireless systems, using discovery or discovery-like signaling To enable automatic discovery of other devices, a dedicated channel may be reserved for this purpose where devices may send a specific discovery signal with a predefined format, so that other devices listening in this channel can know the existence of the transmitters. For example, the discovery signal may be generated by one device for establishing a direct device-to-device communication, the discovery signal comprising a preamble part and a data part which comprises information for establishing the direct device-to-device communication, wherein a preamble resource for the preamble part is determined from a set of predefined resources and a data resource for the data part maps form the preamble resource.

### TECHNICAL FIELD

The exemplary and non-limiting embodiments of this invention relate generally to wireless communications and more specifically to implementing a direct device-to-device communication of cellular devices, e.g., in LTE wireless systems.

### BACKGROUND ART

The following abbreviations that may be found in the specification and/or the drawing figures are defined as follows:

CDM Code Division Multiplexing

D2D Device to Device

DL Downlink

E-UTRA Evolved Universal Terrestrial Radio Access

eNB Evolved Node B/Base Station in an E-UTRAN System

E-UTRAN Evolved UTRAN (LTE)

FDM Frequency Division Multiplexing

ID Identification

LTE Long Term Evolution

LTE-A Long Term Evolution Advanced

OTAC Over-the-air Communications

PRB Physical Resource Block

PDCCH Physical Downlink Control Channel

PDSCH Physical Downlink Shared Channel

PUCCH Physical Uplink Control Channel

PUSCH Physical Uplink Shared Channel

Rx Reception, Receiver

TA Timing Advance

TD Timing Delay

TDM Time Division Multiplexing

Tx Transmission, Transmitter

UE User Equipment

UP Uplink

UTRAN Universal Terrestrial Radio Access Network

Device to Device (D2D) communication is a promising application which could be used to improve the resource usage efficiency, reduce the power consumption at both eNB and UE sides, reduce the traffic in cellular networks, and possibly enable some new services in the future. A new study was proposed for D2D in 3GPP TSG-RAN #52 RP-110706, “On the need for a 3GPP study on LTE device-to-device discovery and communication”, Qualcomm

There are many motivations to introduce the D2D concept, e.g., it may save resources compared with communications via a network, reduce interferences and save power in devices due to low transmit power, shorten end to end delay, etc. But due to existence of the WiFi DIRECT technique which can realize the D2D function, the D2D communication in LTE has to be designed to be more powerful and efficient to compete. Some features expected from the LTE D2D include controlling interference by the eNB and more efficient resource utilization.

These features can be realized by designing an eNB controlled D2D operation, e.g., when a dedicated resource is allocated by the eNB for the D2D operation, and the eNB controls D2D mode configuration. However, if many devices are capable of the D2D operation, using eNB for control pairing and resource allocation for each device will cause a large burden on the eNB signaling. Moreover, in some cases, one user device initially has no desired counterpart to connect to for the D2D operation and it would like to know all the potential users around. In this case, letting the eNB inform other user devices requires accurate position information which may be unavailable. From this point of view, automatic discovery of other devices is desirable.

A synchronization method based on cellular DL transmission timing was proposed for D2D communication, where devices send the discovery signal with the same timing., e.g., synchronized to an external source (see “FlashLinQ: A Clean State Design for Ad Hoc Networks”, slide 15, Qualcomm, internet address: http://www.slideshare.net/zahidtg/flashlinq-a-clean-slate-design-for-ad-hoc-networks).

However, no detailed design for this discovery signal was presented. In the IEEE specification for WiFi (see ANS/IEEE Std 802.11, 1999 Information technology—Telecommunications and information exchange between systems - Local and metropolitan area networks, Specific requirements, Part 11: Wireless LAN Medium Access Control (MAC) and Physical Layer (PHY) Specifications), there is a discovery method which includes sending a probe, then letting the receivers respond at a random time within a feedback window configured by the transmitter. The difference is that in WiFi, one transmission occupies the whole channel, and only TDM is available. The multiplexing capacity of the discovery signal is low and can hardly apply directly to the case of D2D communications for the LTE system.

### SUMMARY

According to a first aspect of the invention, a method comprises: providing a discovery signal by a first device in a wireless network for establishing a direct device-to-device communication, the discovery signal comprising a preamble part and a data part which comprises information for establishing the direct device-to-device communication, wherein a preamble resource for the preamble part is determined from a first set of predefined resources and a data resource for the data part maps from the preamble resource; sending the preamble part using the preamble resource; and sending the data part after sending the preamble part using the data resource.

According to a second aspect of the invention, a method comprises: blindly detecting, by a second device and within a first set of predefined resources, a preamble part of a discovery signal for establishing a direct device-to-device communication; mapping a preamble resource on which the preamble part was detected to a data resource; and receiving in the data resource a data part of the discovery signal comprising information for establishing the direct device-to-device communication.

According to a third aspect of the invention, an apparatus comprises: a processing system comprising at least one processor and a memory storing a set of computer instructions, in which the processing system is arranged to cause the apparatus to provide a discovery signal by a first device in a wireless network for establishing a direct device-to-device communication, the discovery signal comprising a preamble part and a data part which comprises information for establishing the direct device-to-device communication, wherein a preamble resource for the preamble part is determined from a first set of predefined resources and a data resource for the data part maps form the preamble resource; to send the preamble part using the preamble resource; and to send the data part after sending the preamble part using the data resource.

According to a fourth aspect of the invention, an apparatus comprises: a processing system comprising at least one processor and a memory storing a set of computer instructions, in which the processing system is arranged to cause the apparatus to blindly detect, by a second device and within a first set of predefined resources, a preamble part of a discovery signal for establishing a direct device-to-device communication; to map a preamble resource on which the preamble part was detected to a data resource; and to receive in the data resource a data part of the discovery signal comprising information for establishing the direct device-to-device communication.

According to a fifth aspect of the invention, a computer readable memory encoded with a computer program comprising computer readable instructions recorded thereon for execution a method comprising: providing a discovery signal by a first device in a wireless network for establishing a direct device-to-device communication, the discovery signal comprising a preamble part and a data part which comprises information for establishing the direct device-to-device communication, wherein a preamble resource for the preamble part is determined from a first set of predefined resources and a data resource for the data part maps form the preamble resource; sending the preamble part using the preamble resource; and sending the data part after sending the preamble part using the data resource.

According to a sixth aspect of the invention, a computer readable memory encoded with a computer program comprising computer readable instructions recorded thereon for execution a method comprising: blindly detecting, by a second device and within a first set of predefined resources, a preamble part of a discovery signal for establishing a direct device-to-device communication; mapping a preamble resource on which the preamble part was detected to a data resource; and receiving in the data resource a data part of the discovery signal comprising information for establishing the direct device-to-device communication.

### BRIEF DESCRIPTION OF THE DRAWINGS:

For a better understanding of the nature and objects of the present invention, reference is made to the following detailed description taken in conjunction with the following drawings, in which:

FIG. 1 is a schematic diagram showing a wireless system with a group of seven UEs under one cell A and adjacent to another cell B with four UEs, in which exemplary embodiments detailed herein, may be practiced to advantage;

FIG. 2 is a diagram of a discovery signal, according to an exemplary embodiment of the invention;

FIGS. 3a-3c are time-frequency diagrams of resource allocation for a discovery signal, according to exemplary embodiments of the invention;

FIGS. 4a-4b are time-frequency diagrams of resources for a discovery signal and a response to the discovery signal, according to exemplary embodiments of the invention;

FIG. 5 is a flow chart demonstrating generating and sending a discovery signal, according to an exemplary embodiment of the invention;

FIG. 6 is a flow chart demonstrating receiving a discovery signal, according to an exemplary embodiment of the invention; and

FIG. 7 is a block diagram of wireless devices for practicing exemplary embodiments of the invention.

### DETAILED DESCRIPTION

A new method, apparatus, and software related product (e.g., a computer readable memory) are presented for implementing a direct device-to-device (D2D) communication of cellular devices , such as UEs, eNBs (or Node Bs in general), e.g., in LTE wireless systems using discovery or discovery-like signaling.

To enable automatic discovery of other devices, there may be a dedicated channel reserved for this purpose. In this channel, some devices may send a specific signal with a predefined format, and then other devices listening in this channel can know the existence of the transmitters. This dedicated channel is called a discovery channel and the specific signal is called a discovery signal in this document. The following features are desired for the discovery signal design: large multiplexing capacity, guaranteeing accurate detection and providing necessary information of the transmitter. To accomplish this, the issues addressed in various embodiments of the invention for the discovery signal in the discovery channel include but are not limited to: a) multiplexing of discovery signals from different devices; b) arriving time of the discovery signal; c) communication resources for sending the discovery signal; d) detecting the discovery signals from multiple transmitters considering that the discovery signals can arrive with time differences; and e) identifying the transmitters, e.g., device-ID, service-ID, etc.

In LTE wireless systems, FDM, TDM and CDM are all available which provides the possibility to increase the discovery signal multiplexing capacity.

Moreover, the exemplary embodiments described herein may be also applied to other scenarios, e.g., OTAC between eNBs in case no X2 is available. In the OTAC, if one eNB has to communicate with multiple neighboring eNBs, it may need to know the exact receiving timing at first, then where to find the information to be exchanged, identity of the sending eNB, etc. Thus, problems may be similar to what is mentioned above. In various embodiments described herein different design principle for the discovery signaling are disclosed.

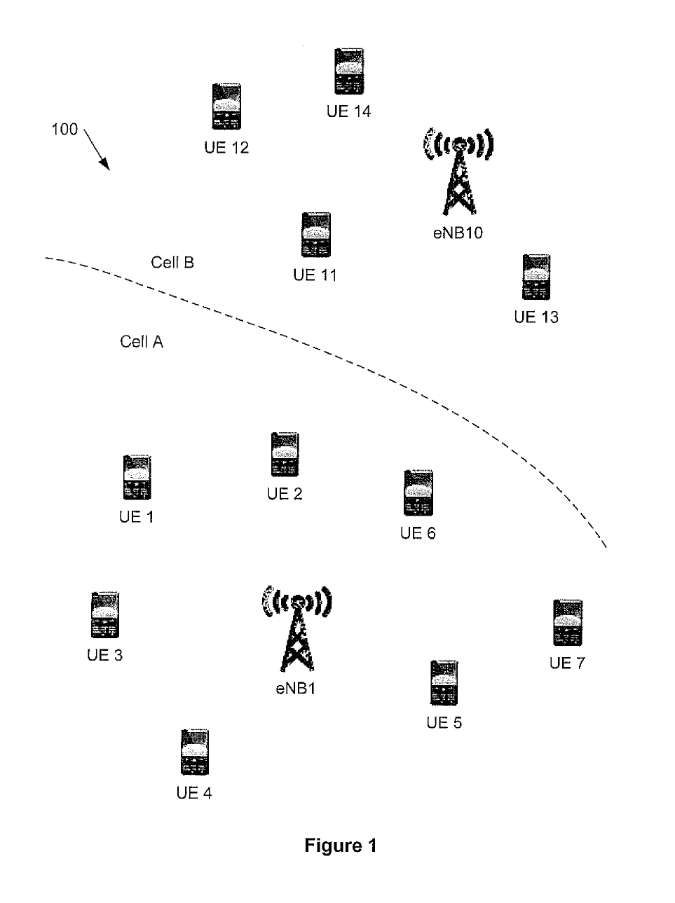

FIG. 1 illustrates an exemplary wireless system in which embodiments of these teachings may be practiced to advantage. Seven UEs, UE-1 through UE-7, are under one cell A with eNB1 and adjacent to another cell B with eNB10 having four UEs UE11-UE14. The discovery signal for D2D communication may be sent by any of the UE1-UE7 or UE11-UE-14 to some other UE/UEs shown in FIG. 1 to establish D2D communication. The D2D communication may be also established using over-the-air communication (OTAC) between neighboring eNBs (for example eNB1 and eNB10 in FIG. 1), as further described herein.

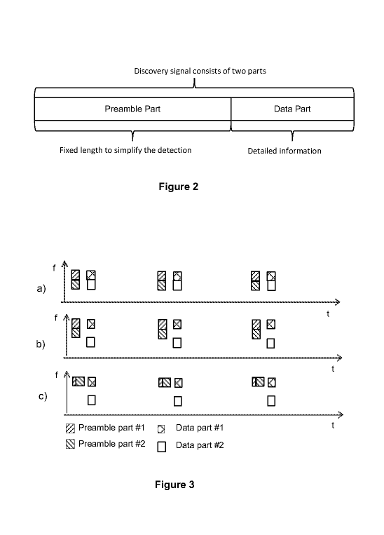

According to exemplary embodiments of the invention the following principles for the discovery signal design may be applied. The discovery signal may consist of two parts, where the first part is a preamble part, while the second part is a data part as shown in FIG. 2. The preamble part and the data part of the discovery signal may be sent in the same or in different subframes, and the preamble part is send before the data part. Transmission of the two parts may be synchronized according to the same timing, e.g., DL Tx timing of the eNB supporting the UE sending the discovery signal (e.g., for UE1-UE-7 it is cell A with eNB1 in FIG. 1).

The preamble part may use a sequence (or identification sequence) such as a Zadoff-Chu sequence with or without a cyclic shift, which helps a receiver to get more exact receiving timing for the discovery signal. The eNB may pre-configure a set of resources for the UEs in the cell to send the preamble. Since the target D2D range is relatively small, the bandwidth of the resource may be also small, e.g., 2PRBs. In the data part, some necessary information for device identification, and/or service identification, and/or parameters for D2D communication, etc. may be transmitted, and cellular transmission format can be reused for simplicity, e.g., PDSCH/PUSCH format, and/or PDCCH/PUCCH format.

Along with the pre-configured (predefined) set of resources for the preamble part, the eNB may pre-configure another set of resources for the data part for the UEs in the cell. There is a predefined one-to-one mapping relationship between a resource for the preamble part and a resource for the data part, i.e., each preamble resource from the predefined set being mapped to only one data resource from another predefined set of resources for the data part. Both of these sets of resources may be made available to all UEs of the cell. Therefore, if the D2D device randomly selects the preamble resource from the set of preamble resources or alternatively if the eNB assigns it upon request from the UE, then the data resource for the discovery signal may be determined using this one-to-one mapping relationship at the transmitter. Similarly, once the preamble part is detected, the receiver would be able to determine the resource for the data part using this one-to-one mapping relationship and then find the data part. It is further noted that the multiplexing technique may be different for the preamble part and the data part, e.g., the preamble part may use CDM while the data part may use FDM, or the preamble part may use FDM while the data part may use TDM, etc.

Thus, the UE, which would like to send a discovery signal, may randomly select a resource for the preamble from the predetermined set of resources and further determine the data resource from another set of predetermined resources using the one-to-one mapping relationship, as discussed herein.

Then the UE which receives the discovery signal may use a time window for the preamble signal detection in the defined resource for the preamble part transmission. The length of the time window in time domain may depend on the desired range for the D2D communication which can be configured by the eNB (as for the window in frequency domain for the detection, the width should be same as the preconfigured resource for the preamble signal, e.g., 2 PRBs).

Detection of the preamble may be blind assuming different timing and different sequences of the preambles from different users, so that the receiver may detect preambles of multiple transmitters. However, the data part detection is not blind due to the information from the preamble part, i.e., the arriving time of the preamble and the one-to-one mapping is utilized to detect the data part based on the data resource determined from the preamble resource, as discussed herein. In an embodiment, mapping from the preamble resource to the data resource depends on the sequence ID of the preamble part.

After detecting the discovery signal, if the receiver, denoted as device A (which can be, for example UE-2), may want to set up a link with the transmitter of the detected discovery signal, denoted as device B (which can be, for example UE-1, it may have multiple options as follows:

Option A. Device A may send a request to the eNB to set up the link; the request may indicate the target device B, the service type or estimation of the traffic load, the pathloss and/or TA, etc.;

Option B. Device A may send a response directly to the transmitter, i.e., the device B, in a response channel; the response channel may be linked to the discovery signal channel and can be known by the receiver device A implicitly; in case the discovery signal is targeted to multiple receivers, CDM can be assumed for the response. The response may indicate the device ID of the device A, the resource reserved for communication with the device B, etc;

Option C. Device A may send a discovery signal in the discovery channel (using the same resources as the received discovery signal from the device B), and may indicate in the data part that the device B as the target receiver, and may further indicate the resource reserved for the following D2D communication with the device B.

It is noted that the proposed discovery signal design is simple to implement in existing devices, since the preamble transmission from the UE is already supported in the current LTE specification.

FIG. 2 shows one exemplary illustration for the two parts of the discovery signal. To simplify the detection, the sequence which may be transmitted in the preamble part may have a fixed length. There are predefined sets of resources for the preamble part and for the data part as discussed herein. The predefined resources may be cell-specific. In this case to allow UEs in different cells to discover each other, at least the reserved predefined set of resources (for the preamble part) should be signaled to the UE by the serving eNB. Since the resources for the data part map from the preamble part, the UEs may not need to know the whole predefined set of data part resources but the eNB does need to set it aside so normal cellular communications do not interfere there. In the predefined resources, different transmissions can be distinguished via a preamble sequence, a cyclic shift, a frequency allocation or a time slot.

It is further noted that the discovery process may cross the cell boundary, e.g., UE1 in the cell A may discover UE11 in the cell B in FIG. 1, if the two cells A and B (or at least the two UEs) coordinate to use the same sets of preamble and data resources.

FIGS. 3a-3c show examples of time-frequency diagrams of resource allocation for a discovery signal for 2 discovery signals (e.g., from two UEs), the first discovery signal represented by Preamble part #1 and Data part #1 and the second discovery signal represented by Preamble part #2 and Data part #2, according to embodiments of the invention. There is a one-to-one mapping between the resource for the preamble part and the resource for the data part. Once the receiver detects the preamble in a preamble resource #i, it will try to detect the data part in a data resource #i, as explained herein. The resources reserved for the preamble part may be less than that reserved for the data part, e.g., 2 PRBs may be reserved for the preamble part transmission while 10 PRBs may be reserved for the data part transmission (not shown in FIGS. 3a-3b to scale).

It is noted that though in the examples shown in FIGS. 3a-3c two resources for the preambles are TDM or FDM, but CDM may be also used for multiplexing. For example, in FIG. 3a, the preamble part and the data part for the first signal have the same first frequency, and the preamble part and the data part for the second signal also have the same frequency but different from the first frequency. Thus in FIG. 3a both data and preamble are FDM. In FIG. 3b, the preamble part and the data part for the first signal have the same first frequency, the preamble part for the second signal has a second frequency different from the first frequency, and the data part of the second part has a third frequency different from both the first and the second frequencies due to different preamble-to-data mapping between those discovery signals. In FIG. 3c, the preamble part and the data part for the first signal have the same first frequency, also the preamble parts for the first and second signals have the same first frequency but different timing. Thus in FIG. 3c the preambles are TDM and the data parts are FDM. Moreover, even though the data part and preamble part shown in FIGS. 3a-3c are transmitted in discontinuous mode, they may be sent continuously in adjacent subframes.

The resources for the discovery signal transmission from each UE may be configured by the eNB (e.g., signaled to the UEs), or, alternatively, they may be determined by the devices themselves. In case the resources are determined by the eNB, collisions among several devices attempting to send discovery signals on the same radio resource at the same time may be avoided at the cost of more signaling. If determined by the device itself, the device may randomly select one resource for the preamble part within the configured resource set (e.g., the set made available to the device by the eNB) and it may also randomly select a preamble ID to send. The discovery signal may be sent periodically or may be sent in bursts, this configuration can be signaled in the data part to let the receiver know and help the receivers decide where to send their own discovery signal.

In case multiple UEs select the same preamble resource, the same preamble ID, and send the respective preamble at the same time, a collision may occur in the preambles and the receiver may not be able to decode the data part of the discovery signal. The possibility of collision can be reduced by configuring more resources for preamble transmission, and using longer ZadOff-Chu sequences for the preamble which could generate more orthogonal sequences. There are also other methods which may be used for implementing embodiments of the invention for collision handling, such as introducing a back-off time as it use as is used in other contention-based protocols.

Many kinds of information can be sent in the data part of the discovery signal, which may include (but is not limited to): the transmitter's ID, the target receiver's ID, resources reserved for D2D communication with another device, and services which may be supported by transmitter among others.

It is noted that the discovery signals may be sent without any indication of the receiver's identification because the transmitter does not know with whom to establish the D2D communication yet and is going through the discovery process of potential candidates for the D2D communication. Alternatively, the transmitter may indicate the identification of the receiver in the data part as discussed herein. In another embodiment, this indication of the receiver identity may be comprised in the preamble. Then any receivers not identified in the preamble would not bother mapping to or decoding the data part but may automatically discard the discovery signals which are not addressed to them, which will further save processing and power resources and improve user experience.

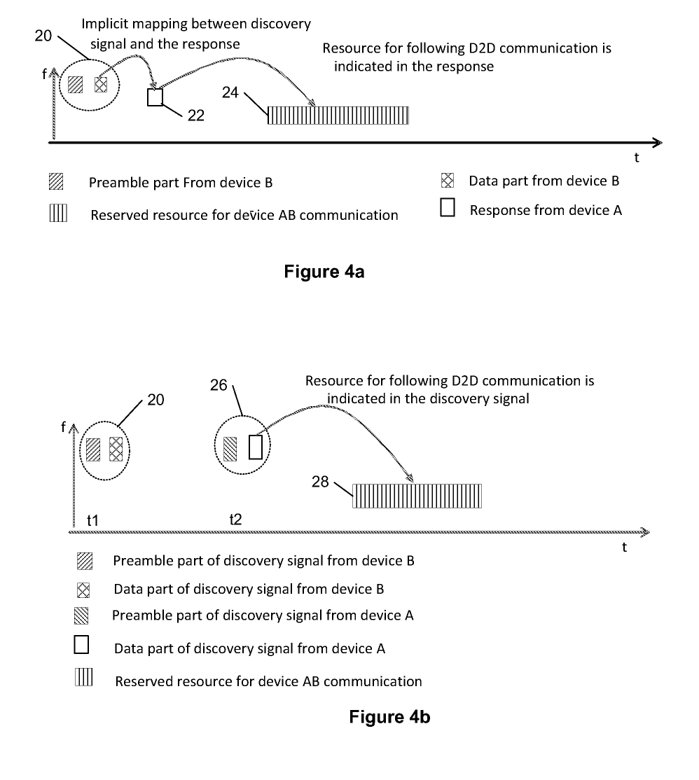

FIG. 4a-4b shows examples of time-frequency diagrams including a response to a discovery signal 20, according to embodiments of the invention. After detecting the discovery signal, the receiver may send the request to the eNB asking to help to set up the link as in the option A as discussed herein. Alternatively, as shown in FIG. 4a, the receiving device may also send a discovery signal response 22 to the transmitter and indicate in that response the reserved resource 24 for the following D2D communication (e.g., between UE1 and UE1 in FIG. 1). Alternatively, the option C as shown in the FIG. 4b may be further utilized. In the example of FIG. 4b, the device A detects the discovery signal 20 from the device B at time t1, then the device A sends its own discovery signal 26 at time t2 and it indicates in the discovery signal that the target receiver is the device B, and further indicates the reserved resource 28 for A-B communication (e.g., between UE1 and UE1 in FIG. 1).

Furthermore, it is noted that this method may be also applied to eNB OTAC. For example, one eNB may have multiple neighbor eNBs and they need to exchange interference information (e.g., eNB1 and eNB10 in FIG. 1). In case OTAC is to be used for such information transmission, the receiving eNB first needs to know the exact sampling time for the transmitted information. By making the OTAC signal to have the preamble part and the data part, as described herein, the receiving eNB can determine the exact arrival timing of the signal from preamble sequence detection, and then to find the detailed information from the data part. The difference from that of the discovering process for the D2D is that the response to the discovery signal (OTAC signal) may not be needed, i.e., the response options A-C may not be necessary in this case.

Thus, the exemplary embodiments disclosed herein provide a solution for coordination of D2D communication in LTE wireless systems by empowering the receiving device to detect discovery signal from multiple transmitters, provide efficient multiplexing for the discovery signal transmission, enabling efficient detection of the discovery signal and enabling necessary information transmission in the discovery signal.

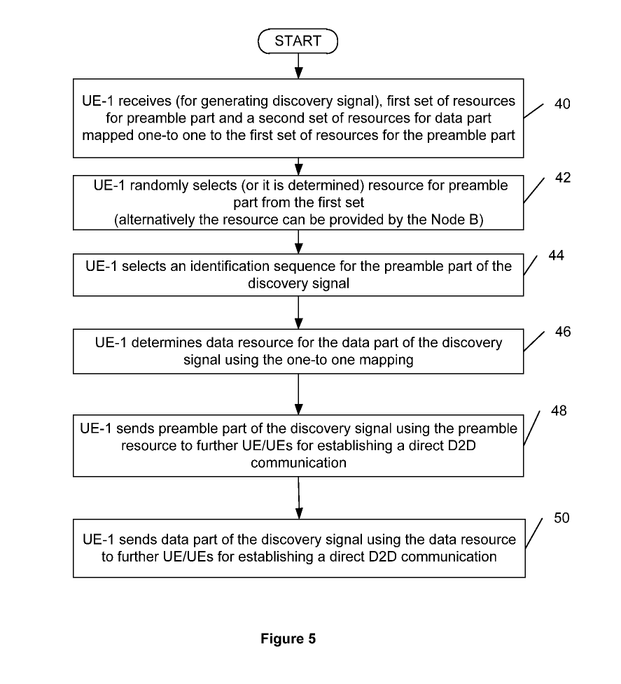

FIG. 5 shows an exemplary flow chart demonstrating generating and sending a discovery signal, according to an exemplary embodiment of the invention. It is noted that the order of steps shown in FIG. 5 is not absolutely required, so in principle, the various steps may be performed out of the illustrated order. Also certain steps may be skipped, different steps may be added or substituted, or selected steps or groups of steps may be performed in a separate application.

In a method according to this exemplary embodiment, as shown in FIG. 5, in a first step 40 a UE-1 receives (e.g., from eNB) a first set of resources for the preamble part and a second set of resources for the data part mapped one-to one to the first set of resources for the preamble part. In a next step 42, the UE-1 randomly selects a preamble resource for the preamble part from the first set of resources. According to an alternative embodiment, instead of steps 40 and 42, the preamble resource may be provided by the Node B per request from the UE-1.

In a next step 44, the UE-1 selects an identification sequence or the like for the preamble part of the discovery signal. In a next step 46, the UE-1 determines a data resource for the data part of the discovery signal using the one-to one mapping with the preamble resource as described herein.

In a next step 48, the UE-1 sends the preamble part of the discovery signal using the preamble resource to a further UE or UEs (e.g., to one or more of UE1-UE7 in FIG. 1) for establishing a direct D2D communication with at least one UE. In a final step 50, the UE-1 sends the data part of the discovery signal using the data resource to a further UE or UEs (e.g., to one or more of UE1-UE7 in FIG. 1) for establishing the direct D2D communication with the at least one UE.

It is further noted that steps 42-50 may be performed by a Node B (e.g., eNB1 in FIG. 1) for communication with another Node B, such as eNB10, using the OTAC signal according to another embodiment of the invention.

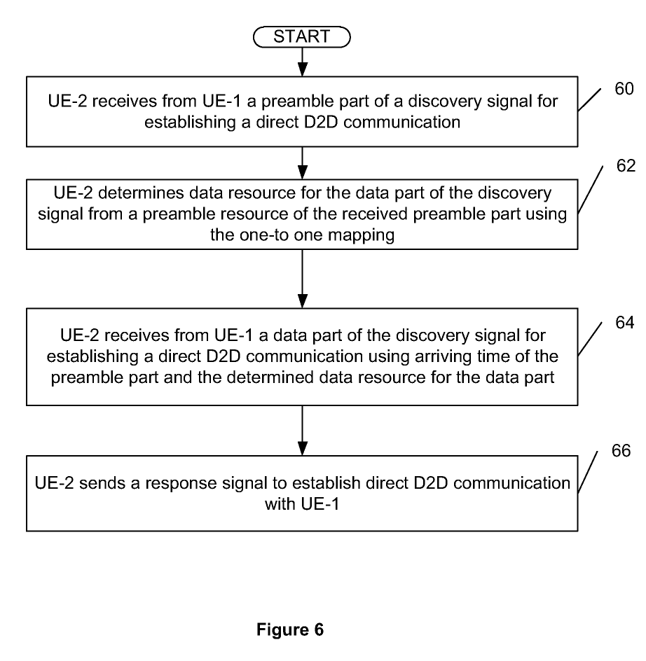

FIG. 6 shows an exemplary flow chart demonstrating receiving a discovery signal, according to an exemplary embodiment of the invention. It is noted that the order of steps shown in FIG. 5 is not absolutely required, so in principle, the various steps may be performed out of the illustrated order. Also certain steps may be skipped, different steps may be added or substituted, or selected steps or groups of steps may be performed in a separate application.

In a method according to the exemplary embodiment, as shown in FIG. 6, in a first step 60 a UE-2 receives, e.g., from UE-1 (see FIG. 1) a preamble part of a discovery signal for establishing a direct D2D communication. In a next step 62, the UE-2 determines data resource for the data part of the discovery signal from a preamble resource of the received preamble part using the one-to-one mapping, as disclosed herein. In a next step 64, the UE-2 receives from UE-1 a data part of the discovery signal for establishing direct D2D communication using arriving time of the preamble part and the determined data resource for the data part. In a final step 66, the UE-2 sends a response signal to establish direct D2D communication with UE-1 using option A, B or C disclosed herein.

It is further noted that steps 60-66 may be performed by a Node B (e.g., eNB10 in FIG. 1) for communicating with another Node B (e.g., eNB1) in FIG. 1 using the OTAC signal according to another embodiment of the invention.

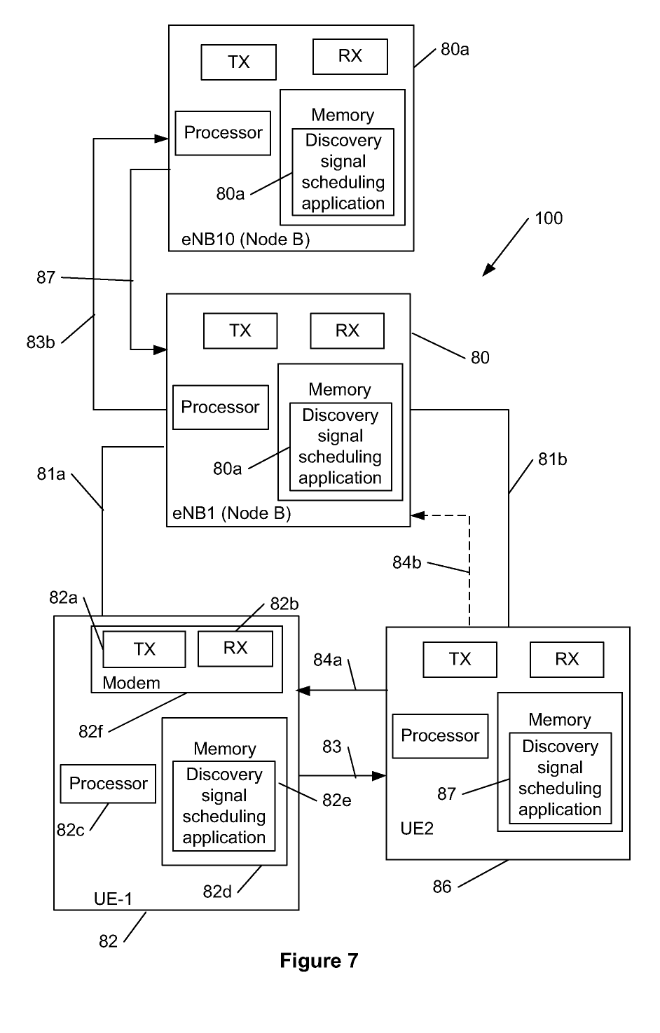

FIG. 7 shows an example of a block diagram demonstrating LTE devices including an eNB1 80 and eNB10 80a, UE1 82 and UE2 86 s comprised in a cellular network 100, according to an embodiment of the invention. FIG. 7 is a simplified block diagram of various electronic devices and apparatus that are suitable for use in practicing the exemplary embodiments of this invention, e.g., in reference to FIGS. 1, 2, 3a-3c, 4a-4b, 5 and 6, and a specific manner in which components of an electronic device are configured to cause that electronic device to operate. Each of the UEs 82 and 86 may be implemented as a mobile phone, a wireless communication device, a camera phone, a portable wireless device and the like.

The UE1 82 may comprise, e.g., at least one transmitter 82a at least one receiver 82b, at least one processor 82c at least one memory 82d and a discovery signal scheduling application module 82e. The transmitter 82a and the receiver 82b and corresponding antennas (not shown in FIG. 7) may be configured to provide wireless D2D communications with UE-1 86 (and others not shown in FIG. 7) and with eNB1 80, respectively, according to the embodiment of the invention. The transmitter 82a and the receiver 82b may be generally means for transmitting/receiving and may be implemented as a transceiver, or a structural equivalence (equivalent structure) thereof. It is further noted that the same requirements and considerations are applied to transmitters and receivers of the other UEs 84, 86, 88 etc. of the cluster 85.

Furthermore, the UE1 82 may further comprise communicating means such as a modem 82f, e.g., built on an RF front end chip of the CH 82, which also carries the TX 82a and RX 82b for bidirectional wireless communications via data/control wireless links 81a, 83, 84a, for sending/receiving discovery signal and communicating with the eNB1 80. The same concept is applicable to other devices 80, 80a and 86 shown in FIG. 7.

Various embodiments of the at least one memory 82d (e.g., computer readable memory) may include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the processor 82c include but are not limited to general purpose computers, special purpose computers, microprocessors, digital signal processors (DSPs) and multi-core processors. Similar embodiments are applicable to memories and processors in other devices 80, 84, 86, 88 shown in FIG. 7.

The discovery signal scheduling application module 82e may provide instructions for generating, sending and/or receiving discovery signal as described herein and illustrated in FIGS. 1, 2, 3a-3c, 4a-4b, 5 and 6. For example, the discovery signal 83 may be sent to the UE2 86 and the signal 84a may be a response from the UE-2 86. The module 82e may be implemented as an application computer program stored in the memory 82d, but in general it may be implemented as a software, a firmware and/or a hardware module or a combination thereof. In particular, in the case of software or firmware, one embodiment may be implemented using a software related product such as a computer readable memory (e.g., non-transitory computer readable memory), computer readable medium or a computer readable storage structure comprising computer readable instructions (e.g., program instructions) using a computer program code (i.e., the software or firmware) thereon to be executed by a computer processor.

Furthermore, the module 82e may be implemented as a separate block or may be combined with any other module/block of the cluster head 82 or it may be split into several blocks according to their functionality. Moreover, it is noted that all or selected modules of the cluster head 82 may be implemented using an integrated circuit (e.g., using an application specific integrated circuit, ASIC).

The other UEs, such as UE2 86, eNB1 80 and eNB10 80a may have similar components as the UE 82, as shown in FIG. 7, such that the above discussion about components of the UE 82 is fully applied to the components of the UE2 86, eNB1 80 and eNB10 80a. The discovery signal scheduling application module 87 in the devices 86, 80, 80a, is similar to the discovery signal scheduling application module 82e in the UE1 82, but is designed to facilitate performing corresponding functions for establishing corresponding discovery functions for establishing D2D communication as described herein and illustrated in FIGS. 1, 2, 3a-3c, 4a-4b, 5 and 6. The module 87 may be implemented as a software, a firmware and/or a hardware module or a combination thereof. In particular, in the case of software or firmware, one embodiment may be implemented using software related product such as a computer readable memory (e.g., non-transitory computer readable memory), a computer readable medium or a computer readable storage structure comprising computer readable instructions (e.g., program instructions) using a computer program code (i.e., the software or firmware) thereon to be executed by a processor.

Furthermore, the module 87 may be implemented as a separate block or may be combined with any other module/block of the cluster head 87 or it may be split into several blocks according to their functionality. Moreover, it is noted that all or selected modules of the device 82, 86, 80 or 80a may be implemented using an integrated circuit (e.g., using an application specific integrated circuit, ASIC).

It is noted that various non-limiting embodiments described herein may be used separately, combined or selectively combined for specific applications.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the present invention. Numerous modifications and alternative arrangements may be devised by those skilled in the art without departing from the scope of the invention, and the appended claims are intended to cover such modifications and arrangements.

1. A method comprising:
providing a discovery signal by a first device in a wireless network for establishing a direct device-to-device communication, the discovery signal comprising a preamble part and a data part which comprises information for establishing said direct device-to-device communication, wherein a preamble resource for the preamble part is determined from a first set of predefined resources and a data resource for the data part maps from the preamble resource;
sending the preamble part using the preamble resource; and
sending the data part after sending the preamble part using the data resource.

2. The method of claim 1, wherein the first device is one of a first user equipment and a first evolved Node B.

3. The method of claim 1, wherein the preamble resource is determined by the first device randomly selecting from within the first set of predefined resources.

4. The method of claim 1, wherein the preamble part comprises at least one of:
an identification sequence and the data resource maps from the preamble resource in dependence on the identification sequence, and
an indication of an identity of the first device.

5. The method of claim 4, wherein said identification sequence is a Zaddof-Chu sequence.

6. (canceled)

7. The method of claim 1, wherein the preamble resource and the data resource are in at least one of: adjacent subframes and different subframes.

8. The method of claim 1, wherein the direct device-to-device communications are established among user equipments in one cell.

9. (canceled)

10. The method of claim 1, wherein the preamble part is synchronized in time using downlink transmit timing of a network access node.

11. The method of claim 1, wherein the first device learns the set of predefined resources from signaling received from a network.

12. The method of claim 1, wherein said information for establishing the direct device-to-device communication comprises at least one of:
an identification of at least the first device,
a resource reserved for the direct device-to-device communication, and
a service supported by the first device.

13. The method of claim 1, wherein said information for establishing the direct device-to-device communication comprises an identification of the first device and of a second device with which the direct device-to-device communication is to be established.

14-19. (canceled)

20. An apparatus comprising:
a processing system comprising at least one processor and a memory storing a set of computer instructions, in which the processing system is arranged to cause the apparatus to:
provide a discovery signal by a first device in a wireless network for establishing a direct device-to-device communication, the discovery signal comprising a preamble part and a data part
which comprises information for establishing said direct device-to-device communication, wherein a preamble resource for the preamble part is determined from a first set of predefined resources and a data resource for the data part maps from the preamble resource;
send the preamble part using the preamble resource; and
send the data part after sending the preamble part using the data resource.

21. The apparatus of claim 20, wherein the first device is one of a first user equipment and a first evolved Node B.

22. The apparatus of claim 20, wherein the preamble resource is determined by the first device randomly selecting from within the first set of predefined resources.

23. The apparatus of claim 20, wherein the preamble part comprises an identification sequence and the data resource maps from the preamble resource in dependence on the identification sequence.

24. The apparatus of claim 20, wherein the preamble resource and the data resource are in at least one of: adjacent subframes and different subframes.

25. (canceled)

26. The apparatus of claim 20, wherein the preamble part is synchronized in time using downlink transmit timing of a network access node.

27. The apparatus of claim 20, wherein the first device learns the set of predefined resources from signaling received from a network.

28. The apparatus of claim 20, wherein said information for establishing the direct device-to-device communication comprises at least one of:
an identification of at least the first device,
a resource reserved for the direct device-to-device communication, and
a service supported by the first device.

29-33. (canceled)

34. A computer readable memory encoded with a computer program comprising computer readable instructions recorded thereon for execution a method comprising:
providing a discovery signal by a first device in a wireless network for establishing a direct device-to-device communication, the discovery signal comprising a preamble part and a data part which comprises information for establishing said direct device-to-device communication, wherein a preamble resource for the preamble part is determined from a first set of predefined resources and a data resource for the data part maps from the preamble resource;
sending the preamble part using the preamble resource; and
sending the data part after sending the preamble part using the data resource.

35. (canceled)
